(19) United States
(12) Patent Application Publication
(10) Pub. No.: US 2025/0233673 A1
(43) Pub. Date: Jul. 17, 2025

(54) OPTICAL ROUTING OF SINGLE PHOTONS FROM TUNEABLE SINGLE PHOTON SOURCES

(71) Applicant: PHOTONIC INC., Coquitlam (CA)

(72) Inventors: Evan MACQUARRIE, Burnaby (CA); Stephanie SIMMONS, Burnaby (CA)

(21) Appl. No.: 18/849,084

(22) PCT Filed: Apr. 21, 2023
(86) PCT No.: PCT/CA2023/050546

§ 371 Date: Sep. 20, 2024

Related U.S. Application Data
(60) Provisional application No. 63/363,613, filed on Apr. 26, 2022.

(51) Int. Cl. H04B 10/70

(52) U.S. Cl. CPC H04B 10/70

(57) ABSTRACT

Methods and systems for routing single photons to selected destinations apply a single photon source optically coupled to a frequency demultiplexer of a photonic network. The frequency demultiplexer comprises plural outputs, each of the outputs is associated with a respective frequency band. A photon from the single photon source is directed to a selected one of the outputs by configuring the single photon source to emit photons having frequencies lying within the one of the frequency bands corresponding to the selected output and controlling the single photon source to emit the photon. The methods and systems may be applied to entangle a quantum state of a quantum system of the single photon source with another quantum system.

### CROSS-REFERENCE TO RELATED APPLICATIONS

This application claims priority from U.S. application No. 63/363,613 filed 26 Apr. 2022 and entitled OPTICAL ROUTING OF SINGLE PHOTONS FROM TUNEABLE SINGLE PHOTON SOURCES which is hereby incorporated herein by reference for all purposes. For purposes of the United States of America, this application claims the benefit under 35 U.S.C. § 119 of U.S. application No. 63/363,613 filed 26 Apr. 2022 and entitled OPTICAL ROUTING OF SINGLE PHOTONS FROM TUNEABLE SINGLE PHOTON SOURCES which is hereby incorporated herein by reference for all purposes.

### FIELD

This technology relates to quantum information management. Aspects of the technology relate to photonic networks for routing single photons and associated methods. The technology has example application in selectively entangling quantum states of quantum systems such as qubits.

### BACKGROUND

Low-loss single photon routing networks are needed in multiple fields including telecommunications, optical computing, quantum networking, and quantum computing. A photon routing network may be configured to accept a single photon at an input and to selectively direct the single photon to one or a plurality of outputs. Photon routing networks may be applied to selectively direct single photons to different locations and/or to selectively apply different photonic processing to a single photon.

Typical single photon routing networks include electrically controlled optical switches that can be set by applying suitable control signals to route single photons from specific sources to specific outputs as required.

A problem with applying optical networks that include active switches for switching single photons is that active switches can result in undesirably high losses. This may not be a problem when working with continuous wave light or large amplitude photon packets where the light being switched includes a very large number of photons such that losses of photons may have no effect or only a negligible effect on a desired outcome. However, when operating at the single photon level any photon loss can be significant.

Another problem arises in the case where selective photon routing is required in a cryogenic environment. There are problems with using optical networks that include active switches in cryogenic environments. These problems include the thermal load caused by heat dissipation from active switches and heat conduction on electrical conductors for control signals (these problems are especially significant where it is desired to operate the switching network in a very low temperature environment—e.g. at temperatures below a few Kelvin). Also, at very low temperatures many active optical switches do not operate well or are very slow to switch between states.

There is a need for low-loss optical routing networks and methods that perform at cryogenic temperatures. There is a particular need for such networks and methods that are effective for routing single photons.

### SUMMARY

The present invention includes a number of aspects. These include:
methods for entangling quantum states of selected pairs of quantum systems;
methods for routing single photons to selected destinations;
systems and apparatuses for entangling quantum states of selected pairs of quantum systems; and
systems and apparatuses for routing single photons to selected destinations.

One aspect of the inventions provides a method for routing single photons to selected destinations, the method comprising: providing a single photon source optically coupled to a frequency demultiplexer of a photonic network, the frequency demultiplexer comprising a plurality of outputs, each of the plurality of outputs associated with a respective frequency band; and directing a photon from the single photon source to a selected one of the outputs by configuring the single photon source to emit photons having frequencies lying within the one of the frequency bands corresponding to the selected output and controlling the single photon source to emit the photon.

In some embodiments the frequency demultiplexer comprises an optical waveguide coupled to the single photon source and a plurality of frequency selective dropout filters optically coupled to the waveguide, each of the dropout filters configured to couple photons from the optical waveguide to a corresponding one of the outputs if the photons have frequencies within the one of the frequency bands associated with the one of the outputs and the method comprises coupling the photon from the optical waveguide to the selected output by the dropout filter corresponding to the selected output.

In some embodiments each of the dropout filters comprises a resonator having a bandwidth that includes the frequency band of the corresponding one of the outputs.

In some embodiments the method comprises coupling the photon from the single photon source to the frequency demultiplexer by way of a resonant optical structure that has an optical bandwidth that includes all of the frequency bands.

In some embodiments the resonant optical structure is characterized by a first quality factor (Q1) and the resonators of the dropout filters each has a corresponding second quality factor (Q2) and the second quality factors are greater than the first quality factor.

In some embodiments for each of the dropout filters the ratio Q2/Q1 is in the range of about 10 to about 10³.

In some embodiments the single photon source and the frequency demultiplexer are each cooled to cryogenic temperatures. For example, the single photon source and the frequency demultiplexer may be maintained at temperatures not exceeding 5 Kelvins.

In some embodiments the single photon source comprises a quantum system having plural quantum states and controlling the single photon source to emit the photon comprises configuring the quantum system in a first quantum state corresponding to a first energy level and allowing the quantum system to undergo a transition from the first quantum state to a second quantum state having a second energy level lower than the first energy level, the photon being emitted as a result of the transition.

In some embodiments configuring the quantum system in the first quantum state comprises causing the quantum system to undergo a spin-selective transition from an initial state to the first quantum state.

In some embodiments the method comprises configuring the quantum system in the initial quantum state wherein the initial quantum state is a superposition of plural spin states.

In some embodiments the quantum system comprises a luminescent center in a substrate. The luminescent center may comprise a T-center, I-center or an M-center.

In some embodiments the single photon source is a first single photon source, the photon is a first photon and the method further comprises routing the first photon from the first single photon source to an interaction location and routing a second photon from a second single photon source to the interaction location and allowing the first and second photons to interact at the interaction location.

In some embodiments routing the second photon from the second single photon source to the interaction location comprises directing the second photon to the interaction location and configuring the second single photon source to emit second photons having frequencies lying within a wavelength band that corresponds to a selected output of a second frequency demultiplexer of the photonic network, controlling the second single photon source to emit the second photon and coupling the second photon into the second frequency demultiplexer of the photonic network.

In some embodiments the method comprises entangling quantum states of the first and second single photon sources.

In some embodiments configuring the single photon source to emit photons having frequencies lying within the one of the wavelength bands comprises setting one or more of a magnetic field and an electric field at a location of the single photon source.

Another aspect of the invention provides a method for entangling quantum states of one or more pairs of qubits, the method comprising: providing plural qubits coupled to a photonic network; selecting a first pair of qubits from the plural qubits; setting energy levels of each qubit of the first pair of qubits to emit photons having a first common frequency into the photonic network in response to excitement of the qubit; and executing a heralded entanglement protocol on the first pair of qubits, the heralded entanglement protocol comprising frequency selecting photonic states corresponding to the first common frequency and associated with the pair of qubits and routing the frequency selected photonic states in the photonic network to an interference unit.

In some embodiments the first pair of qubits comprises first and second qubits and the frequency selection of the photonic states is performed by first and second frequency demultiplexers respectively located in optical paths of the photonic network taken by photons from the first and second qubits of the first pair of qubits respectively.

In some embodiments the plural qubits are each coupled to the photonic network by a corresponding optical resonator.

In some embodiments the first and second frequency demultiplexers each comprise a drop out filter operative to redirect photonic states in a first frequency band that includes the common frequency to a branch waveguide. The drop out filter may comprise a resonator that is tuned to be resonant over the first frequency band. The resonator may be dynamically tunable in response to a control signal.

In some embodiments a Q factor of the optical resonator is less than a Q factor of the drop out resonator by a factor of at least 10.

In some embodiments the optical resonators provide coupling of photons into the photonic network over a frequency range that includes a plurality of distinct frequency bands including the first frequency band.

In some embodiments the plurality of frequency bands includes at least 5 distinct frequency bands. Each of the plurality of frequency bands may have a bandwidth of at least 10 MHz. The optical resonators may have bandwidths of at least about 1 GHz.

In some embodiments setting energy levels of each qubit of the first pair of qubits comprises setting magnitudes of electrical fields at locations of each qubit of the pair of qubits. In some embodiments setting energy levels of each qubit of the first pair of qubits comprises setting magnitudes of magnetic fields at locations of each qubit of the pair of qubits. In some embodiments setting energy levels of each qubit of the first pair of qubits comprises setting magnitudes of strain in a substrate at locations of each qubit of the pair of qubits.

In some embodiments the method may further comprise: selecting a second pair of qubits from the plurality of qubits; setting energy levels of each qubit of the second pair of qubits to emit photons having a second common frequency different from the first common frequency into the photonic network in response to excitement of the qubit; and executing the heralded entanglement protocol on the second pair of qubits, the heralded entanglement protocol comprising in the photonic network frequency selecting photonic states corresponding to the second common frequency and associated with the second pair of qubits and routing the frequency selected photonic states to a second interference unit.

Another aspect of the invention provides a method for routing single photon states to selected destinations for interaction, the method comprising: providing plural qubits coupled to a photonic network wherein each of the plural qubits is controllable to emit photons having any of a set of two or more distinct frequencies; selecting a pair made up of first and second qubits from the plural qubits; setting one or more energy levels of the first qubit of the pair of qubits to emit photons having a first frequency selected from the set of frequencies; setting one or more energy levels of the second qubit of the pair of qubits to emit photons having the first frequency; controlling the first and second qubits to respectively emit first and second photon states having the first selected one and the second selected one of the set of frequencies respectively; coupling the first and second photon states into the photonic network; in the photonic network directing each of the first and second photon states to an interaction zone by frequency selective coupling of the respective photon states to one of a plurality of optical paths provided by the photonic network; and allowing the first and second photon states to interact at the interaction zone.

In some embodiments the interaction zone is provided by an interference unit having first and second input ports and the method comprises directing the first photon state to the first input port of the interference unit and directing the second photon state to the second input port of the interference unit. The interference unit may have first and second output ports and the method comprises detecting a photon at the first output port, the second output port or each of the first and second output ports of the interference unit.

In some embodiments the method comprises executing a heralded entanglement protocol on the pair of qubits. In some embodiments the frequency selective coupling of the first and second photon states is performed by first and second frequency demultiplexers respectively associated with the first and second qubits. The method may comprise, for each of the plural qubits, providing an optical resonator that enhances coupling of the qubit to a waveguide of the photonic network.

In some embodiments each of the optical resonators has a bandwidth that includes the frequencies of the set of two or more distinct frequencies. In some embodiments the frequency selective coupling of the respective photon states to one of a plurality of optical paths is performed by a respective drop out filter operative to couple photonic states at the corresponding frequency to a branch waveguide.

Another aspect of the invention provides a system for routing single photons to selected destinations, the system comprising: a first single photon source optically coupled to a first frequency demultiplexer of a photonic network, the frequency demultiplexer comprising a plurality of outputs, each of the plurality of outputs associated with a respective one of a plurality of frequency bands; and a control system operative to selectively set frequencies of photons emitted by the first single photon source to a frequency within one of the plurality of frequency bands and to cause the single photon source to emit photons into the photonic network.

In some embodiments the single photon source comprises a quantum system having a plurality of quantum states, each of the quantum states having a corresponding energy level and the controller comprises a light source operative to excite the quantum system to a quantum state associated with an excited one of the energy levels via a first quantum transition by directing light onto the quantum system. The first quantum transition may be a spin selective transition.

In some embodiments the controller is configured to configure the quantum system into a quantum state that is a superposition of first and second spin states prior to exciting the quantum system.

In some embodiments the frequency demultiplexer comprises an optical waveguide coupled to the single photon source and a plurality of frequency selective dropout filters optically coupled to the waveguide, each of the dropout filters configured to couple photons from the optical waveguide to a corresponding one of the outputs if the photons have frequencies within the one of the frequency bands associated with the one of the outputs. Each of the dropout filters may comprise a resonator having a bandwidth that includes the corresponding frequency band.

In some embodiments the system comprises a resonant optical structure operative to couple single photons from the single photon source into the photonic network. The resonant optical structure may have an optical bandwidth that includes all of the frequency bands. In some embodiments the resonant optical structure is characterized by a first quality factor (Q1) and the resonators of the dropout filters each has a corresponding second quality factor (Q2) and the second quality factors are greater than the first quality factor.

In some embodiments for each of the dropout filters the ratio Q2/Q1 is in the range of about 10 to about 10³. The system may comprise a resonant optical structure operative to couple single photons from the single photon source into the photonic network. In some embodiments the system comprises a refrigerator operative to cool the single photon source and the photonic network to cryogenic temperatures. The refrigerator may be operative to cool the single photon source and photonic network to temperatures of 5 Kelvins or lower.

In some embodiments the single photon source comprises a luminescent center in a substrate. The photonic network may be formed on and/or in the substrate. The luminescent center may comprise a T-center, I-center of an M-center.

In some embodiments the system comprises a second single photon source coupled to emit photons into a second frequency demultiplexer of the photonic network, the second frequency demultiplexer comprising a plurality of outputs, each of the plurality of outputs associated with a respective one of the plurality of frequency bands, wherein the control system is operative to selectively set frequencies of photons emitted by the second single photon source to a frequency within one of the plurality of frequency bands and to cause the second single photon source to emit photons into the photonic network.

In some embodiments the photonic network comprises an interaction location and one output of each of the first and second frequency demultiplexers is optically connected to deliver photons to the interaction location. The one output of each of the first and second frequency demultiplexers may correspond to the same one of the set of frequency bands. The interaction zone may comprise an interference unit.

In some embodiments the interference unit has first and second output ports and the system comprises first and second single photon detectors respectively connected to detect photons at each the first and second output ports of the interference unit.

In some embodiments the system comprises three or more single photon sources including the first single photon source, each of the three or more single photon sources optically connected to a corresponding frequency demultiplexer of the photonic network, and the control system is configured to direct photons emitted by any of a plurality of pairs of the single photon sources to one of a plurality of interaction zones provided in the photonic network by setting the single photon sources of one of the pairs of single photon sources to emit photons having frequencies that correspond to the one of the plurality of interaction zones. The plurality of interaction zones may be provided by a plurality of interference units. The controller may be configured to execute a heralded entanglement protocol to entangle quantum states of the pair of single photon sources.

Another aspect of the invention provides an apparatus for selectively entangling quantum states of a pair of qubits, the apparatus comprising: plural qubits coupled to a photonic network; a control system operative to set frequencies of photons emitted by the plural qubits by adjusting energy levels of the plural qubits; and, included in the photonic network, plural frequency demultiplexers, each of the frequency demultiplexers coupled to receive photons from a respective one of the plural qubits, each of the frequency demultiplexers configured to frequency select photonic states and to route the frequency selected photonic states to one of a plurality of interference units. Each of the interference units may be associated with one pair of the plurality of qubits.

In some embodiments each of the interference units has first and second inputs which are connected to one output of a first one of the frequency demultiplexers and one output of a second one of the frequency demultiplexers respectively. The one output of a first one of the frequency demultiplexers and the one output of a second one of the frequency demultiplexers may correspond to the same frequencies.

Other aspects of the invention relate to apparatuses and methods having any new and inventive feature, combination of features, or sub-combination of features as described herein.

It is emphasized that the invention relates to all combinations of the above features, even if these are recited in different claims.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1A is a schematic diagram of a dynamic single photon routing network according to an example embodiment.

FIG. 1B is a plot of superposed schematic resonance curves, for example qubits, resonators and optical cavities of FIG. 1A.

FIG. 1C is a schematic diagram of a plurality of optical transitions available to a qubit according to an example embodiment.

FIG. 2A is a schematic illustration of a ring resonator according to an example embodiment.

FIG. 2B is a plot that superposes example schematic resonance curves for qubits and resonators of FIG. 2A.

FIG. 2C is a schematic illustration of a portion of a photonic routing network according to an example embodiment that includes several ring resonators that operate as drop-out filters.

FIG. 3 is a schematic illustration of a dynamic single photon routing network adapted to perform heralded entanglement according to an example embodiment.

FIG. 3A is a schematic illustration of a photonic circuit adapted to perform heralded entanglement according to an example embodiment.

FIG. 4 is a flow chart of an example method for heralded entanglement.

### Definitions

“Optical photon” means a photon having a wavelength in the optical region of the spectrum (e.g. in the range of far infrared to ultraviolet). Photons having wavelengths in the range of 700 nm to 2000 nm are examples of optical photons.

“Entanglement” describes the situation in which quantum states of individual quantum systems in a group of two or more quantum systems cannot be described independently of the quantum states of the other ones of the quantum systems in the group. An equivalent definition of an entangled state is a quantum state of a group made up of plural quantum systems that cannot be factored into states of the individual quantum systems that make up the group. For example, two entangled particles that each possess intrinsic spin may each have a quantum state which is a superposition of spin up and spin down while the combined spin of the two particles is constrained to be zero. Entanglement can exist even between quantum systems that are separated by very large distances.

“Highly entangled state” means a state that is maximally entangled or close to being maximally entangled. A Bell pair is an example of a highly entangled state.

“Qubit” means a quantum system that has first and second quantum states that can be used to represent quantum information and which can exist in a quantum superposition. Examples of quantum systems that may be used as qubits include particles that have intrinsic spin (e.g. electrons, atomic nuclei, holes) where different spin states may represent information; particles that have excitonic states where the absence or presence of an exciton may represent information, particles e.g. electrons that have different orbital states where the orbital state occupied by the particle represents information and so on.

“Qutrit” means a quantum system that has three or more quantum states that can be used to represent quantum information and can exist in quantum superpositions. A particle having an intrinsic spin greater than ½ may, for example be applied as a qutrit.

“Matter qubit” means a qubit that includes quantum states of a material particle such as an atom, electron, atomic nucleus, ion, or the like that possesses mass. “Matter qubits” are distinguished from “flying qubits” (e.g. photons) which are massless and travel at light speed.

“Broker” means a qubit that is applied as a conduit to transfer a quantum state deterministically to another qubit (client qubit).

“Client qubit” means a qubit that receives transfer of a quantum state from a broker qubit.

“Quantum system” means a system that has practical application for storing and/or manipulating quantum information. A quantum system supports plural quantum states and superpositions of at least two supported quantum states.

Examples of quantum systems are spins (e.g. electron spins, nuclear spins), qubits, qutrits, quantum dots, damage centers such as T, I and M centers, NV centers, impurity atoms in silicon or other substrates and collections of two or more of these.

“Indistinguishable photons” or “indistinguishable photon states” mean photons or photon states that have the same wavelength, polarization, lifetime, and temporal and spatial extent such that they cannot be distinguished from one another.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

The present technology relates to systems and methods for dynamically routing light in a photonic network. The systems and methods are applicable to routing single photons from single photon sources. The systems and methods may be used at cryogenic temperatures. The systems and methods have example application in quantum computing and quantum information processing.

Those of skill in the art understand that individual photons generally do not have definite wavelengths or frequencies due to the Heisenberg uncertainty principle which relates uncertainty in any photon's location to uncertainty in the photon's momentum (which depends on the photon's energy). A photon's energy is related to the photon's wavelength and frequency. Therefore there is uncertainty in the wavelength or frequency of any single photon. A single photon can be understood to be characterized by a wavelength distribution (and a corresponding frequency distribution) and a corresponding energy distribution. Despite the foregoing, it is possible to selectively interact with single photons that have different wavelength distributions. For convenience, this description uses the term “wavelength” of a single photon to mean the “wavelength distribution” of the single photon and the term “frequency” of a single photon to mean the “frequency distribution” of the single photon.

Wavelength and frequency of a photon are related by c=λv where c is the speed of light, λ is the wavelength and v is the frequency. Any wavelength has a corresponding frequency and vice versa. The energy of a photon is related to the frequency of the photon by E=hv where E is the energy, h is Planck's constant, and v is the frequency.

One aspect of the invention provides systems that include one or more single photon sources connected to emit photons into a photonic network. The single photon sources may, for example comprise quantum systems that emit photons when undergoing corresponding quantum transitions. The single photon sources are controllable to emit photons of different frequencies. For example, frequencies of emitted photons may be set by setting energy levels of quantum states between which optical transitions that emit photons can occur.

The photonic network is configured to demultiplex photons based on their frequencies (or equivalently their wavelengths). The routing of single photons emitted by a single photon source through the photonic network may be set by controlling the single photon source to emit photons having selected frequencies and may be altered by controlling the single photon source to change the frequencies of emitted photons. The configuration of the photonic network itself may remain fixed.

For example, the photonic network may receive a photon from the single photon source on one optical path and may selectively present the photon on one of a plurality of optical paths based on the energy (frequency) of the photon.

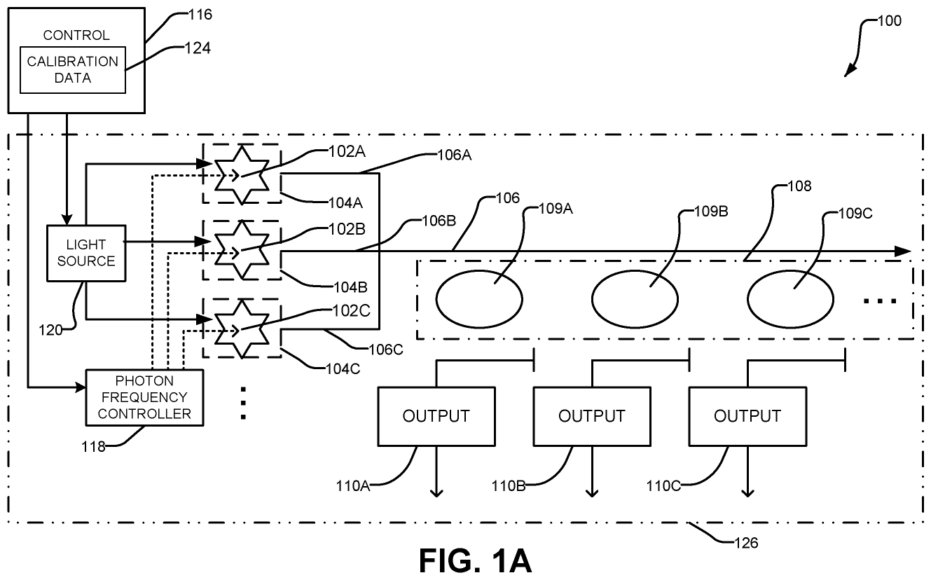

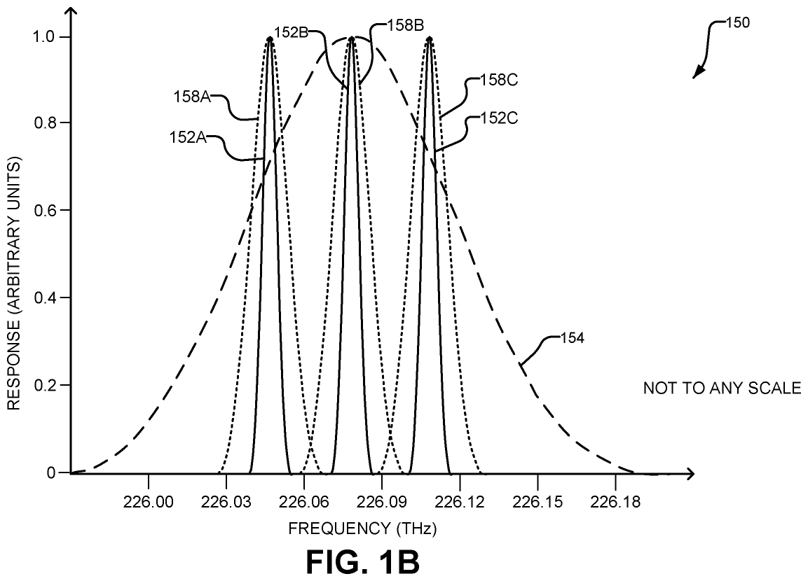

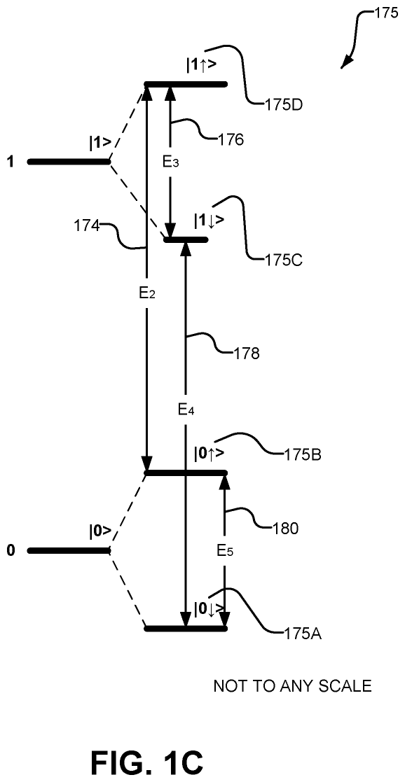

FIG. 1A schematically depicts a simple example photonic network 100 according to an example embodiment. Photonic network 100 is configurable to selectively direct photons from a quantum system 102 to a corresponding one of a plurality of outputs 110 (individually shown as outputs 110A, 110B, 110C and 110D). In some embodiments photonic network 100 has in the range of 2 to 2000 or 2 to 100 or 2 to 50 or 2 to 25 outputs 110.

FIG. 1A shows photonic network 100 comprising a single quantum system 102. However, it is to be understood that a network 100 may be scaled and configured to route photons from any practical number of quantum systems 102. Quantum systems 102 may, for example, have quantum states that may be used as qubits.

Quantum systems 102 may for example comprise matter qubits on or embedded in a suitable substrate (e.g. a crystalline substrate such as silicon or diamond). For example, quantum systems 102 may each comprise an impurity or defect or luminescent centre (e.g. an ion, donor atom, T-centre, I-centre or M-centre) that possesses one or more unpaired electron spins and/or one or more unpaired nuclear spins.

Quantum system 102 is optically coupled to a corresponding waveguide 106. A resonant optical structure 104 (e.g. an optical resonator which may, for example, comprise a photonic cavity) facilitates coupling of photons from quantum system 102 into waveguide 106. As discussed in more detail below, resonant optical structure 104 is resonant with photons emitted by quantum system 102.

Waveguide 106 is optically coupled to a frequency demultiplexer 108. In FIG. 1A, demultiplexer 108 comprises a series of drop out filters 109 (filters 109A, 109B and 109C are shown). Each of drop out filters 109 is tuned to couple any passing photons propagating in waveguide 106 that have energy (frequency) in a corresponding range to a corresponding output (outputs 110A, 110B and 110C are shown). Drop out filters 109 may, for example comprise resonators (e.g. ring resonators) that are optically coupled between waveguide 106 and the corresponding output 110.

In some embodiments, drop out filters 109 are tunable. Tuning capability may be used for any of: correcting for manufacturing variations; selectively configuring demultiplexer 108 to set frequency bands for drop out filters 109 so that photons having different frequencies are routed in desired ways; and dynamically reconfiguring demultiplexer 108 in operation to change which photon frequency band corresponds to each of one or more routing paths. In some embodiments, photon frequency bands for drop out filters 109 of demultiplexer 108 are set prior to operation. For example, a controller for network 100 (e.g. controller 116 as discussed below) may include a data store that contains control values for setting drop out filters 109 to respond to photons in different frequency bands. The controller may apply the control values to set frequency bands for drop out filters for operation. In some embodiments, drop out filters 109 are dynamically reconfigured to adjust operation of photonic network 100.

Tunable drop out filters may, for example, comprise a layer of electro-optical material adjacent to a ring resonator. The resonant frequency of the ring resonator may then be altered by applying a control voltage to the electro-optical material. The control voltage may be set by a controller of network 100. Tuning of drop out filters 109 may be set to optimally distribute corresponding filterbands within the spectral range accessible by quantum systems 102.

The bandwidth for each drop out filter 109 may be somewhat greater than the linewidths of photons emitted by quantum system 102 so that a photon having a frequency corresponding to the center of one of the frequency bands will, with a high probability, be coupled out of waveguide 106 to the corresponding output 110 by the corresponding dropout filter 109.

The resonators of drop out filters 109 may have resonance curves that are substantially non-overlapping such that a photon that has a high probability of being coupled out of waveguide 106 by one resonator 109 has a very small probability of being coupled out of waveguide 106 by any other ones of resonators 109.

To direct a photon from quantum system 102 to output 110A, quantum system 102 may be controlled to emit a photon that has a frequency (energy) corresponding to a drop out filter 109A. With a high probability the photon will be coupled to output 110A by drop out filter 109A. In general, quantum system 102 may be controlled to emit a photon that has a frequency (energy) corresponding to any selected one of drop out filters 109 to cause the photon to be presented at the corresponding output. In some embodiments, quantum system 102 may be caused to emit a photon that has a frequency that does not correspond to any of drop out filters 109 such that the photon continues on waveguide 106 (e.g. to output 110D).

Resonant optical structure 104 is configured to facilitate coupling photons having frequencies corresponding to any one of outputs 110 into waveguide 106. This may be achieved, for example, by configuring resonant optical system 104 to have a sufficiently low quality factor (Q) where Q is approximately given by the ratio of the resonant frequency to the full width at half maximum bandwidth of the resonance curve for resonant optical structure 104. For the same resonant frequency a reduction of Q results in increased bandwidth (and reduced selectivity). Conversely, increasing Q results in decreased bandwidth (and increased selectivity). Typically a higher Q factor corresponds to a narrower bandwidth but stronger resonance response and a lower Q factor corresponds to a broader bandwidth but relatively weaker resonance response.

FIG. 1B is a plot showing an example resonance curve 154 for resonant optical structure 104 superposed with example resonant curves 158A to 158C which respectively correspond to dropout filters 109A to 109C and corresponding emission lines 152A to 152C for photonic emissions that quantum system 102 may be caused to emit at different frequencies.

Optical resonant structure 104 serves to enhance the radiative emission of photons from quantum system 102 and to couple emitted photons into waveguide 106. Optical structure 104 may thereby improve performance of quantum system 102 as a spin-photon interface. Optical structure 104 is tuned to respond to a sufficient degree with photons having frequencies corresponding to any of drop out filters 109. To achieve this, the bandwidth of the resonance indicated by resonance curve 154 is large enough to include all of emission lines 152 that correspond to photons that it is desired to route by way of a corresponding drop out filter 109.

For example, in some embodiments the resonance curve for optical structure 104 has a bandwidth that exceeds about 1 GHz. For example, the bandwidth of optical structure 104 may be in the range of about 1 GHz to about 100 GHz.

A range within the bandwidth of optical structure 104 may be divided into bands that correspond to different routing by network 100. For instance, if optical structure 104 has a bandwidth of 100 GHz approximately 1000 bands with center frequencies spaced apart by about 100 MHz could be accommodated within the bandwidth of optical structure 104. Where the linewidth of photons emitted by quantum system 102 is significantly less than 100 MHz photons having frequencies corresponding to adjacent bands may be readily separable. If desired, fewer bands may be provided with a larger distance between adjacent bands.

The tuning of optical structure 104 may advantageously be fixed. In some embodiments optical structure 104 has a controllable resonant frequency.

Resonance curves 158 for drop out filters 109 have bandwidths significantly narrower than that of resonance curve 154. Each of resonance curves 158A to 158C has negligible overlap with neighboring resonance curves 158 such that the likelihood that a photon intended to be taken off of waveguide 106 by a particular drop out filter 109 will be taken off instead by another drop off filter 109 is small. Resonance curves 158 may be fixed during operation of photonic network 100.

To cause a photon emitted by quantum system 102 to be routed to a particular one of outputs 110 one can control quantum system 102 so that emitted photons will have a frequency 152 that corresponds to the desired output 110. For example, energy levels of quantum system 102 may be adjusted so that an emitted photon has a frequency (emission line 152) that corresponds to drop out filter 109A (i.e. a frequency that overlaps sufficiently with resonance curve 158A). Emission line 152A does not overlap significantly or at all with other resonance curves, such as 158B and 158C. Therefore, photons emitted from quantum system 102 have a probability of being routed to any of outputs 110B, 110C or 110D that is very small.

Optical linewidths for single photons emitted as a result of a quantum transition of quantum system 102 may be small. For example, in some embodiments, the linewidth of photons emitted as a result of transitions between quantum states of quantum systems 102 may be less than about 1 GHz (e.g. in the range of about 100 kHz to about 1 GHz). Frequency bands corresponding to different drop out filters 109 may be spaced apart sufficiently to allow effective downstream separation of photons having frequencies in adjacent frequency bands as discussed below.

Optical structure 104 may be characterized by a quality factor Q1. In some embodiments, the quality factor Q1 of optical structure 104 is less than about 10⁵ (e.g. in the range of about 10³ to about 10⁵).

Drop out filters 109, whether provided by optical resonators or other mechanisms, may have quality factors Q2. In preferred embodiments, quality factors Q2 are greater than quality factor Q1. By making Q2 large, each drop out filter 109 may have a high response to an emitted photon only if the photon has a frequency near the center of a corresponding one of the frequency bands that are designated for photons from quantum system 102. Incorporating relatively high Q drop out filters 109 facilitates fitting several separable frequency bands within the spectral range accessible to the cavity-enhanced photonic emissions from quantum systems 102.

The performance of network 100 and the maximum practical number of frequency bands that can be used to route photons in photonic network 100 vary with the ratio of Q2:Q1. A larger ratio of Q2:Q1 enables a larger maximum number of frequency bands. In some embodiments, the ratio Q2/Q1 is in the range of about 10 to about 10³.

Network 100 may be modified to include:
more drop out filters 109 and corresponding outputs 110,
more quantum systems 102 (which may be coupled to deliver photons into a common waveguide 106 or different waveguides 106),
more levels of filtering (for example, a relatively broadband drop out filter 109 may deliver photons having frequencies in any of a plurality of frequency bands to an output connected to a further waveguide 106 which is associated with drop out filters 109 that correspond to each of the plurality of frequency bands),
other devices for detecting, modifying and/or allowing interaction of photons,
etc.

Network 100 comprises a controller 116 which is configured and connected to coordinate operation of network 100. Controller 116 includes a photon frequency controller 118 and light source 120.

Photon frequency controller 118 is operable to set the energy of the quantum transition in quantum system 102 that yields photons (and therefore to affect the frequencies of emitted photons).

FIG. 1C is a schematic diagram showing an example set of quantum states 175A through 175D (collectively and generally quantum states 175) of a simple quantum system 102. A plurality of transitions, 174, 176, 178 and 180 are available between different ones of the quantum states 175.

Quantum system 102 may be made to emit a photon, for example, by exciting quantum system 102 from one of states 175A and 175B to one of states 175C or 175D (e.g. by illuminating the quantum system 102 with light from light source 120) and then allowing quantum system 102 to transition to one of states 175A and 175B, emitting a photon in the process. Selection rules may limit the transitions that are achievable. For example quantum system 102 may be cycled to emit photons by transition 174 between state 175D and state 175B.

The frequency of emitted photons may be adjusted by varying the relative energy levels of the quantum states between which the transition occurs. This may be done in various ways such as varying the magnitude of a magnetic field at quantum system 102, varying the magnitude of an electric field at quantum system 102, applying strain to a substrate in which quantum system 102 is located etc. In some embodiments a photon frequency shifter is provided between quantum system 102 and demultiplexer 108 (various devices may be used for shifting the frequencies of single photons—an example is described in S. Buddhiraju et al., Arbitrary linear transformations for photons in the frequency synthetic dimension, 23 Apr. 2021, Nature Communications. DOI: 10.1038/s41467-021-22670-7). Photon frequency controller 118 may, for example, apply any of these effects or any combination of these effects to generate photons having selected frequencies that correspond to selected routing in network 100.

Photonic network 100 of FIG. 1A includes a frequency controller 118 operable to set the energy of an optical transition of quantum system 102 and thereby set the frequency of photon states corresponding to the transition in quantum system 102. Where network 100 includes plural quantum systems 102 frequencies of photons emitted by each of quantum systems 102 may be individually controlled by photon frequency controller 118. Photon frequency controller 118 may for example control one or more of electric field, magnetic field and strain at the location of a quantum system 102 with one of or the combination of two or more of these control inputs set to correspond to a desired photon frequency.

In some embodiments, photon frequency controller 118 stores or accesses plural settings for causing a quantum system 102 to emit photons of different frequencies. Each of the different frequencies may lie within a corresponding frequency band. Photons having frequencies lying within each frequency band may be routed the same way by network 100 even if their frequencies are not identical.

In some embodiments dedicated settings are provided for individual ones of quantum systems 102. The settings may be established by a calibration procedure (e.g. a procedure which varies one or more parameters of photon frequency controller 118 and measures frequencies of photons emitted by a quantum system 102 and/or monitors how resulting photons are routed by network 100 for each set of one or more parameter values). The dedicated settings may be stored and subsequently used to cause the quantum system 102 to emit one or more photons that will be routed in a particular way by network 100.

In some embodiments, photon frequency controller 118 operates to vary an electric field at the location of quantum system 102. The electric field may, for example, alter energy levels of the quantum system 102 by the Stark effect. Each quantum system 102 may be configured to emit photons having a selected frequency by applying a corresponding electric field at the location of the quantum system 102.

For example, each quantum system 102 of photonic network 100 may be located in a gap between a corresponding pair of electrodes. The electric field at the qubit 102 may be set by applying an electrical potential difference across the gap to a level which causes emitted photons to have a desired frequency.

For example, potential differences and/or magnetic fields corresponding to plural photon frequencies may be established by a calibration routine and stored for access by photon frequency controller 118. In some embodiments, the electric field strength at the location of a quantum system 102 is set to have a value in the range of about 0.1 MV/m to about 30 MV/m. Different values may correspond to different selected photon frequencies.

Photonic network 100 includes light sources (e.g. lasers) 120 that are operable to emit light to individually excite quantum systems 102 into excited states from which the quantum systems 102 may transition to emit photons. In some embodiments, each of a plurality of quantum systems 102 is paired with a laser 120 for excitation. Lasers 120 may be individually controlled by controller 116. In some embodiments light from a single laser 120 may be delivered to a selected one or more of a plurality of quantum systems by controllable optics.

Controller 116 has access to calibration data 124. Calibration data 124 includes information that may be applied in the control of photonic network 100. For example, calibration data 124 may comprise information such as a table of parameter values (e.g. voltages) for setting frequencies of photons emitted by each quantum system 102 and/or a table of parameter values (e.g. voltages) for setting tuning of drop out filters 109. Parameter values included in calibration data 124 may be determined by performing calibration routines.

In the illustrated embodiment, photonic network 100 is in a cryostat 126 that is operable to maintain photonic network 100 at a desired operating temperature. In some embodiments the operating temperature is 5 Kelvin (5 K) or lower. In some embodiments the operating temperature is 1.5 Kelvin or lower.

In some embodiments, only parts of photonic network 100 are maintained at a cryogenic operating temperature. For example, quantum systems 102 may be maintained at a cryogenic temperature and all or part of demultiplexer 108 may be maintained at a higher operating temperature. In some embodiments, demultiplexer 108 is operated at a temperature that is at or close to room temperature.

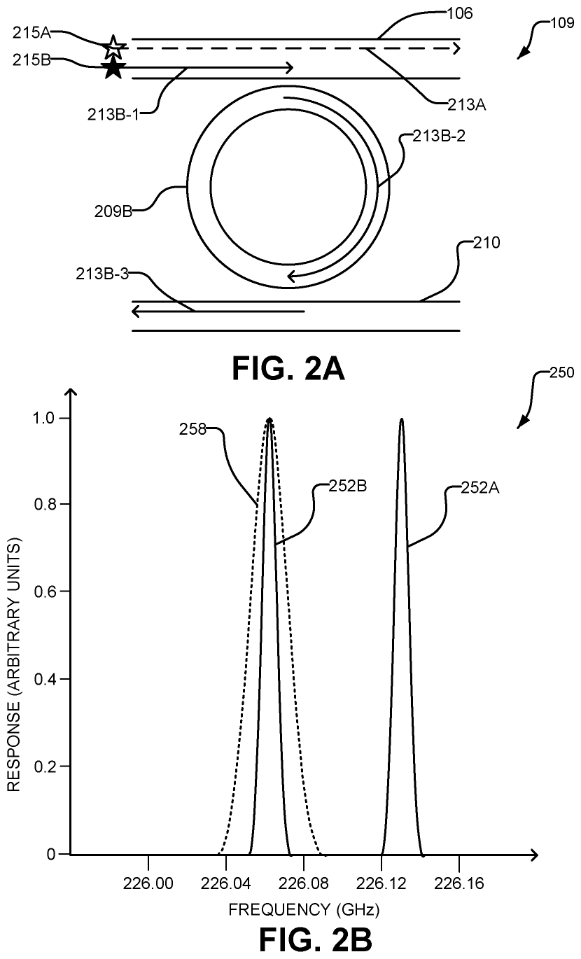

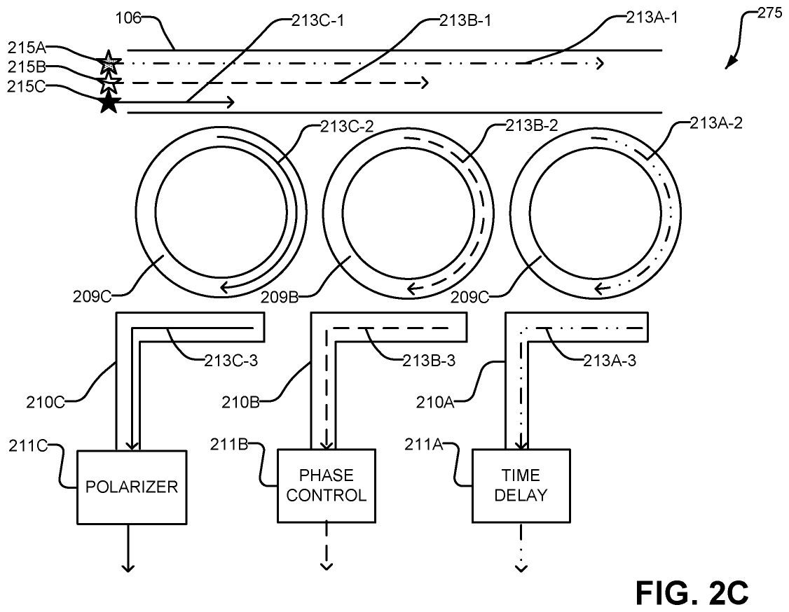

FIG. 2A schematically depicts an example construction for a drop out filter 109 that includes a ring resonator 209B located between and evanescently coupled to each of waveguide 106 and output waveguide 210. Emitted photons 215A and 215B which have different frequencies travel along waveguide 106. Photons 215B have frequencies at or close to the resonant frequency or ring resonator 209B. On the other hand, photons 215A have frequencies that do not resonate with ring resonator 209B.

In FIG. 2A, when both photons 215A and 215B pass by ring resonator 209B, photon 215B is redirected by ring resonator 209B from path 213B-1 to path 213B-2 and subsequently onto path 213B-3. On the other hand, photon 215A continues on path 213A substantially unaffected by the presence of ring resonator 209B. As a result, ring resonator 209B directs photons of in a frequency band which includes the frequency of photon 215B onto output waveguide 210 with a high probability without affecting photons having frequencies outside of the frequency band.

FIG. 2B is a plot 250 which schematically shows a resonance curve 258 of ring resonator 209B and frequency distributions 252A and 252B that correspond respectively to photons 215A and 215B.

Frequency distribution 252B has significant overlap with resonance curve 258 which leads to a high probability that photons 215B will be coupled out of waveguide 106 into ring resonator 209B. In some embodiments, a peak of frequency distribution 252B is at a frequency that corresponds to a value of resonance curve 258 that is at least 60% or 70% or 80% or 90% of a maximum value of resonance curve 258. By contrast, frequency distribution 252A does not overlap significantly or at all with resonance curve 258 (i.e. for all parts of frequency distribution 252A that have values exceeding 10% of a maximum of frequency distribution 252A the corresponding values for resonance curve 258 do not exceed 5% of the maximum value of resonance curve 258. Therefore there is a very low probability that a photon 215A will be coupled out of waveguide 106 into ring resonator 209B.

FIG. 2C schematically depicts drop out filters implemented using ring resonators 209A to 209C each coupled to a corresponding one of outputs 210A to 210C. Emitted photons 215A to 215C travel along waveguide 106. In the particular example embodiment of FIG. 2C, photons 215A are resonant with ring resonator 209A. Photons 215B are resonant with ring resonator 209B. Photons 215C are resonant with ring resonator 209C. As a result, each of photons 215A to 215C is respectively coupled out of waveguide 106 to a corresponding one of outputs 210A to 210C.

In some embodiments, resonance curves for resonators 209 are designed (e.g. by designing resonators 209 to have chosen resonance frequencies and Q factors) such that photons having frequencies correspond to the resonant frequency of a resonator 209 have a probability of at least 90% or higher of being coupled out of waveguide 106 by the resonator 209.

A photonic network 100 is not limited to selectively directing single photons to different outputs. A photonic network 100 may be configured to selectively manipulate states of photons that are emitted into the network 100 based on their frequencies. For example, a photonic network may perform frequency selective modification of photon properties such as phase, polarization and timing. For example, a network 100 may include optical components that modify these properties such as: polarizers that can act on photons to modify polarization, phase shifting components such as % wave or ½ wave plates that can modify phase, and time shifting components such as optical delay lines that can delay a photon.

After one or more properties of a photon have been modified the photon may be coupled back into waveguide 106 or directed to another part of the photonic network.

The network illustrated in FIG. 2C, provides for modification of properties of photons 215A-C that are redirected onto outputs 210. For example, photon 215C may be passed through a polarizer 211C that may alter a polarization of the photon 215C. The phase of photon 215B may be adjusted by a phase shifter 211B. The timing of photon 215A may be delayed by an optical delay component 211A. Any other suitable manipulation or processing may be implemented.

In a network configured to guide photons emitted from individual quantum systems to different destinations depending on the frequencies of the emitted photons, single photons emitted respectively from first and second quantum systems may be directed in selected paths through the network by causing the emitted photons to have appropriate frequencies. Such systems allow emitted photons to be directed to follow selected paths and/or to be delivered to selected destinations without any active adjustment or control of the network itself (i.e. no active adjustment or control of active optical switches or other elements of the optical routing network is needed). The emitted photons may be directed to selected destinations by controlling energy levels of quantum states in the quantum systems so that frequencies of photons emitted as a result of transitions between selected quantum states of the quantum systems correspond to intended routes through the network and/or selected destinations in the network.

A non-limiting example application of the present technology is to cause interactions of photon states resulting from quantum transitions in different quantum systems. The photon states may be directed to optical components in which suitable interactions are facilitated by a photonic network based on the principles described above. In some embodiments the network is configured so that photons emitted by two quantum systems are brought together to interact with one another when the photons have frequency or frequencies that are in the same frequency band. Interactions between photons emitted from different quantum systems may be used, for example, to create quantum entanglement between the quantum systems. For example, a photonic network may be configured to facilitate heralded entanglement of two quantum systems or a pair of a plurality of quantum systems.

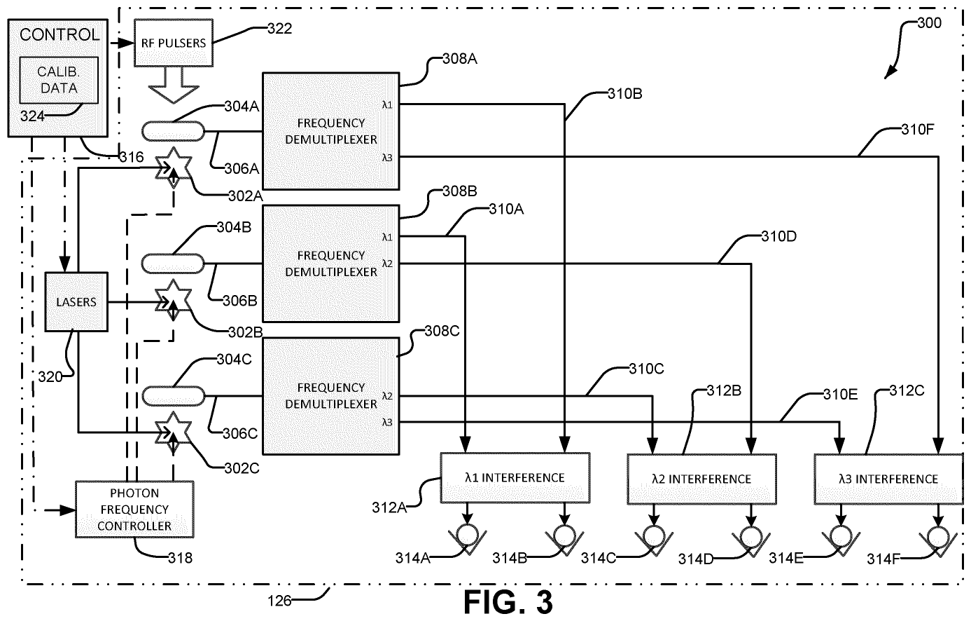

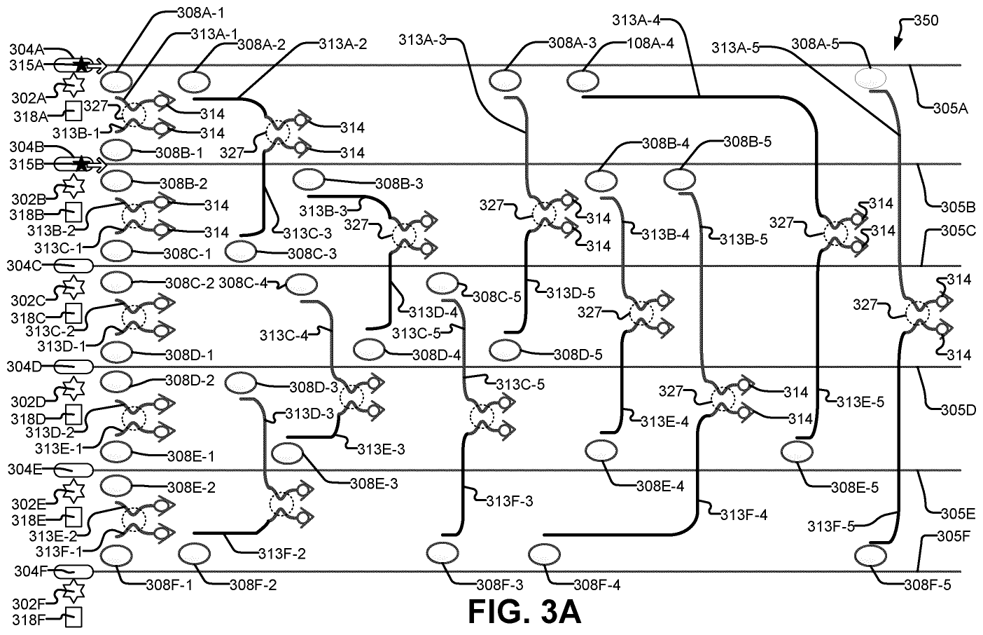

FIG. 3 is a schematic diagram of an example photonic network 300 according to another example embodiment. Network 300 may have any of the features described herein for network 100. One example application of network 300 is to facilitate heralded entanglement of quantum systems 302. Quantum systems 302 may, for example, be of the same types as quantum systems 102.

Network 300 is configurable to selectively direct photons from a pair made up of any two selected quantum systems 302 (individually shown as quantum systems 302A, 302B and 302C) to corresponding inputs of an interference unit 312 (individually shown as interference units 312A, 312B and 312C).

Each interference unit 312 is configured to allow photon states which arrive simultaneously or nearly simultaneously at its input ports to interfere with one another at an interaction zone. Interference units 312 may, for example, comprise optical beam splitters at which photon states may interact with one another. Photon states corresponding to the quantum systems of the selected pair of quantum systems 301 may interfere with one another before arriving at single photon detectors 314 (individually shown as single photon detectors 314A to 314F) located at corresponding output ports of interference units 312. An example application of network 300 is to facilitate selectively entangling quantum states of selected pairs of quantum systems 102.

FIG. 3 shows network 300 as including three quantum systems 302 but it is to be understood that network 300 may be scaled to include any practical number of quantum systems 302. Network 300 may be configurable to support entanglement of quantum states of all possible pairs of the quantum systems 302 or some selected pairs of quantum systems 302.

Each of quantum systems 302 is optically coupled to a corresponding waveguide 306 (waveguide 306A, 306B and 306C are shown) by way of a corresponding optical resonator 304 (resonators 304A, 304B and 304C are shown). Resonators 304 may, for example, each be implemented by an optical cavity. In some embodiments, waveguides 306A-C merge into one waveguide 306.

As mentioned above, quantum systems 302 are tunable to adjust the frequencies (energies) of photons emitted as a result of transitions between quantum states that have different energy levels. A control system e.g. photon frequency controller 318 may be configured to set energy levels of individual quantum systems 302 to emit photons that have frequencies that lie within frequency bands of frequency demultiplexers 308. Photons having frequencies corresponding to (lying within) a frequency band that enter a frequency demultiplexer 308 are routed to a corresponding output of the frequency demultiplexer 308.

Photons emitted by quantum systems 302 and coupled into waveguides 306 are delivered to corresponding frequency demultiplexers 308. Frequency demultiplexers 308A, 308B and 308C are respectively configured to direct photons from corresponding waveguides 306A, 306B and 306C onto one of a plurality of different output paths based on the frequencies of the photons. For example, each frequency demultiplexer (e.g. 308A) may have one output port corresponding to each of a plurality of frequency bands. Photons emitted from quantum systems 302 are routed to outputs corresponding to the frequency bands in which their frequencies lie.

A frequency demultiplexer 308 may, for example, be implemented by a series of drop out filters which may in turn be implemented by resonators (for example ring resonators) as schematically illustrated in FIGS. 1A and 2C. In some embodiments each frequency demultiplexer (e.g. 308A) has in the range of 2 to 1000 or 2 to 50 or 2 to 25 output ports each associated with a corresponding frequency band.

Each frequency demultiplexer (e.g. 308A, 308B, 308C etc.) may include a filter for each output port that allows photons having energy distributions in a corresponding frequency band to reach the corresponding output port and blocks other photons.

In some embodiments, demultiplexing network 308 is provided by an add/drop network built from passive or tunable optical resonators that are each tuned to have a resonance corresponding to photons having energy distributions in a corresponding one of the frequency bands.

In some embodiments, some or all of frequency demultiplexers 308 are provided by an arrayed waveguide grating. In some embodiments, some or all of frequency demultiplexers 308 are provided by an integrated spectrometer with a channel spacing narrow enough to separate photons in the different frequency bands. For example, in some embodiments the channel spacing is in the range of about 1 GHz to about 10 GHz.

Network 300 includes a plurality of interference units 312. Each interference unit 312 has first and second input ports and first and second output ports. Each of the input ports of each interference unit 312 is connected to receive photons from a corresponding output port of one of frequency demultiplexers 308. Photons that have frequencies such that they are routed from individual quantum systems 302 to the corresponding output ports of the frequency demultiplexers 308 are input to the interference unit 312.

Each interference unit 312 is configured to allow photons which arrive simultaneously or nearly simultaneously at its input ports to interfere with one another. Interference units may, for example comprise optical beam splitters. In some embodiments, interference units 312 each comprise a waveguide beamsplitter. The waveguide beamsplitter includes first and second optical waveguides that are formed to provide a section in which the first and second waveguides approach one another closely.

For example, in network 300, interference unit 312A has one input port coupled to output port λ1 of frequency demultiplexer 308B by waveguide 310A and another input port coupled to output port λ1 of frequency demultiplexer 308A by waveguide 310B. By setting energy levels of quantum states of quantum systems 302A and 302B such that emitted photons will have frequencies within the frequency band associated with outputs λ1 and then causing quantum systems 302A and 302B to emit photons the emitted photons will automatically be passed by network 300 to corresponding inputs of interference unit 312A. Due to the interference occurring in interference unit 312, a photon arriving at one input port of the interference unit may be detected by either one of the single photon detectors at the output ports of the interference unit 312.

In some embodiments quantum systems 302 have arrangements of quantum states that permit an optical transition (i.e. a transition between quantum states that have energy levels that differ by an energy corresponding to an optical photon) that is spin-selective (i.e. the transition can occur starting from one spin state of the quantum system 302 but cannot occur or can only occur with a low probability starting from another spin state of the quantum system 302). The transition may result in emission of an optical photon from the quantum system 302. The frequency of optical photons emitted by quantum systems 302 is controllable by altering the energy levels of the quantum states involved in the optical transition.

Note that since quantum systems 102 and 302 are quantum systems they can each exist in a superposition of quantum states, furthermore, up to the time that a measurement is made (e.g. by detecting a photon) network (e.g. 100 or 300) can be in a superposition of states in which a photon has been emitted by a particular quantum system 302 and a photon has not been emitted by the particular quantum system 302. For example, where any photons emitted by quantum systems 302 result from spin-selective transitions whether or not the quantum system 302 will emit a photon depends on its initial quantum state.

For example, suppose that the quantum system comprises an electron spin that when illuminated with light of an appropriate wavelength (“exciting light”) will cause the quantum system to transition to an excited state if the electron spin is spin up and will not transition to the excited state if the electron spin is spin down. From the excited state the electron will transition back to the ground state and emit a photon in the process. If the quantum state of the quantum system includes the electron being spin up when the exciting light is applied then a photon will be emitted. If the quantum state of the quantum system includes the electron being spin down when the exciting light is applied then a photon will not be emitted.

If the electron is in a quantum state which is a superposition of spin up and spin down then after the exciting light is applied the quantum system and network 300 will be in a superposition of a state where no photon was emitted and a state where a photon was emitted. This superposition includes a photon state which can be routed by network 300 to one of interference units 312.

An interference unit 312 together with connected single photon detectors 314 may be applied to create and verify entanglement of two corresponding quantum systems 302 according to an example method of this invention. The interference unit (e.g. a beam splitter) is configured to bring photon states from two paths close to one another thereby allowing them to interfere with each other before arriving at the photon detector(s). For each photon state that enters an interference unit 312, there are two possible outcomes. The photon may either be reflected (stay on its own path) or transmitted (hop onto the other waveguide). For example, a photon from path 310A may either stay on its path and be detected at photon detector 314A or hop onto the other path and be detected at photon detector 314B. Similarly, a photon from path 310B may end up at either photon detector 314A or at photon detector 314B.

If the photon on path 310A and the photon on path 310B are indistinguishable photons and arrive at the interference unit at the same time, the possible outcomes at the photon detectors according to the Hong-Ou-Mandel effect are:
(1) 310A→314A and 310B→314A; and,
(2) 310A→314B and 310B→314B.
   This behavior may be exploited in heralded quantum entanglement protocols to entangle quantum states of two corresponding quantum systems 302.

In a similar manner, interference unit 312B has one input port coupled to output port λ2 of frequency demultiplexer 308C by waveguide 310C and another input port coupled to output port λ2 of frequency demultiplexer 308B by waveguide 310D. By setting energy levels of quantum systems 302B and 302C such that any emitted photons will have frequencies in a frequency band corresponding to outputs λ2 and manipulating quantum systems 302B and 302C so that they may undergo quantum transmissions which would emit photons of having frequencies such that the photons will be routed to outputs λ2, one can cause photon states to be routed to inputs of interference unit 312B so that photons may be detected by single photon detectors 314C and/or 314D. The photons that are routed to outputs λ2 may be indistinguishable photons.

In a similar manner, interference unit 312C has one input port coupled to output port λ3 of frequency demultiplexer 308C by waveguide 310E and another input port coupled to output port λ3 of frequency demultiplexer 308A by waveguide 310F. By setting energy levels of quantum systems 302A and 302C such that any emitted photons will have frequencies such that the photons will be routed to outputs λ3 and manipulating quantum systems 302A and 302C so that they may undergo quantum transmissions which would emit photons of having frequencies such that the photons will be routed to outputs λ3, t one can cause photon states to be routed to inputs of interference unit 312C so that photons may be detected by single photon detectors 314E and/or 314F. The photons that are routed to outputs λ3 may be indistinguishable photons.

A network 300 that includes N quantum systems, may have interconnectivity sufficient to connect any pair of quantum systems 302 to different inputs of one of the interference units 312. This may be achieved for example by providing frequency demultiplexers 308 that each have N−1 outputs with each of the outputs connected to an input of a corresponding interference unit 312. In such a scenario, the number of possible distinct pairs of quantum systems that could be entangled is given by: N×(N−1)/2 where N is the number of quantum systems.

In the particular example photonic network 300 shown in FIG. 3, there are three quantum systems (e.g., N=3). Accordingly, there are a total of three unique entanglement pairs:
(1) entanglement of quantum systems 302A and 302B, which may be heralded by detection of a pattern of photon detections at photon detectors 314A and 314B;
(2) entanglement of quantum systems 302B and 302C, which may be heralded by detection of a pattern of photon detections at photon detectors 314C and 314D; and,
(3) entanglement of quantum systems 302A and 302C, which may be heralded by detection of a pattern of photon detections at photon detectors 314E and 314F.

It is not necessary for network 300 to be configured to facilitate entanglement of every possible pair of quantum systems 302. Network 300 may comprise any desirable number of interference units to facilitate a corresponding desirable number of possible entanglement pairs.

Network 300 may comprise state manipulation means for manipulating quantum states of quantum systems 302. The state manipulation means may, for example, comprise RF pulsers 322 and/or light sources controlled by controller 316. RF pulsers 322 are operable to apply RF pulses to manipulate quantum states of quantum systems 302. For example, quantum gates may be applied to any of quantum systems 302 by applying RF pulses having frequencies resonant with a transition between states of the quantum system 302 for a time period selected to achieve a desired alteration of the quantum state of the quantum system. For example, the RF pulses may flip a spin in a quantum system. In some embodiments, each quantum system is paired with a corresponding RF pulser. The RF pulsers may be individually controlled by controller 316 to manipulate the quantum state of a corresponding quantum system 302.

FIG. 3A is a schematic illustration of a photonic circuit 350 that is an example implementation of a photonic network that operates on the same principles as photonic network 300.

Photonic circuit 350 optically interfaces to six quantum systems 302A-F by way of six corresponding optical cavities 304A-F. Wavelength controllers 318A-F are operable to adjust energy levels of respective quantum systems 302A-F thereby setting the frequencies of photons emitted as a result of transitions between quantum states of the respective quantum systems.

Primary waveguides 305A to 305F (generally or collectively waveguides 305) extend respectively from corresponding optical cavities 304A to 304F. Photons coupled into waveguides 305 from the corresponding qubits 302 are guided to travel along the corresponding waveguide 305.

Along each waveguide 305 are photonic structures that act as drop out filters. A photon having a wavelength corresponding to one of these drop out filters will, with a high likelihood, be directed out of the waveguide 305 to a corresponding branch waveguide.

In photonic circuit 350 the drop out filters are implemented by optical resonators disposed adjacent to and spaced apart along each waveguide 305. For example, disposed adjacent to and along waveguide 305A extending from optical cavity 304A are five optical resonators 308A-1, 308A-2, 308A-3, 308A-4 and 308A-5. Each of these optical resonators is set to respond strongly to a particular band of frequencies that is within the frequency band range of optical cavity 304A. For example, optical resonators 308A-1 to 308A-5 may respectively respond strongly to photons having wavelengths λ1 to λ5 respectively and may each redirect photons of the corresponding frequencies onto a corresponding one of branch waveguides 313A-1 to 313A-5 (generally and collectively branch waveguides 313).

Optical resonators 308A-1 to 308A-5 serve as a frequency demultiplexer 308 for qubit 302A. Each branch waveguide 313 is respectively coupled to a single photon detector 314.

Each branch waveguide 313 is formed to include an interaction zone 327 in which a photon state in the branch waveguide 313 can interact with another photon state. In the illustrated embodiment interaction zone 327 is provided by a location at which the branch waveguide 313 passes close to a corresponding branch waveguide associated with another one of primary waveguides 305. For example, branch waveguide 313A-5 shares an interaction zone 327 with a corresponding branch waveguide 313F-5 that branches off from waveguide 305F. An interaction zone may also be called an “interaction location”.

In interaction zones 327 photon states travelling in either branch waveguide may interfere with one another. Other designs that facilitate interference between photon states may also be applied.

To facilitate interference between photonic states at interaction zones 327, photon states originating from two quantum systems (e.g. 315A and 315B) should be indistinguishable photon states that arrive at the interaction zone at the same or nearly the same time.

In some embodiments, photonic circuit 350 is constructed so that the path lengths from two quantum systems to the corresponding interaction zone 327 are equal. For example, the total path length from quantum system 302A to interaction zone 327 by way of branch waveguide 313A-1 and the total path length from quantum system 302B to the interaction zone by way of branch waveguide 313B-1 may be the same. Therefore, if photons 315A and 315B are emitted simultaneously, they should arrive at interaction zone 327 at the same time. In some embodiments, the relative timing by which two quantum systems 302 are caused to emit photons is controlled to compensate for any difference in path lengths from this pair of quantum systems to the corresponding interaction zone 327 (e.g. by delaying excitation of the quantum system for which the path length to the corresponding interaction zone 327 is shorter).

In the illustrated photonic circuit 350 each principal waveguide 305 has a set of optical resonators spaced apart along it (308B-1 to 308B-5 for waveguide 305B, 308C-1 to 308C-5 for waveguide 305C, 308D-1 to 308D-5 for waveguide 305D, 308E-1 to 308E-5 for waveguide 305E and 308F-1 to 308F-5 for waveguide 305F). Each of these optical resonators is coupled to a photon detector by a corresponding branch waveguide (313A-1 to 313A-5, 313B-1 to 313B-5, etc.).

In photonic circuit 350 a pair of single photon detectors 314 corresponds to every possible pair of quantum systems 302A to 302F. In alternative embodiments some pairs of photon detectors may be omitted.

Photonic circuit 350 routes photons of the same frequency to each pair of photon detectors. Thus one can use photonic circuit 350 to perform heralded entanglement of any pair of quantum systems 302A to 302F by configuring both quantum systems of the selected pair to emit photons having frequencies that will cause the photons to be routed to the interaction zone 327 that is common to the selected pair of quantum systems 302. Heralded entanglement may, for example, be performed using the procedure described in S. D. Barrett and P. Kok, Phys. Rev. A 71, 060310(R) (2005) which is hereby incorporated herein by reference for all purposes.

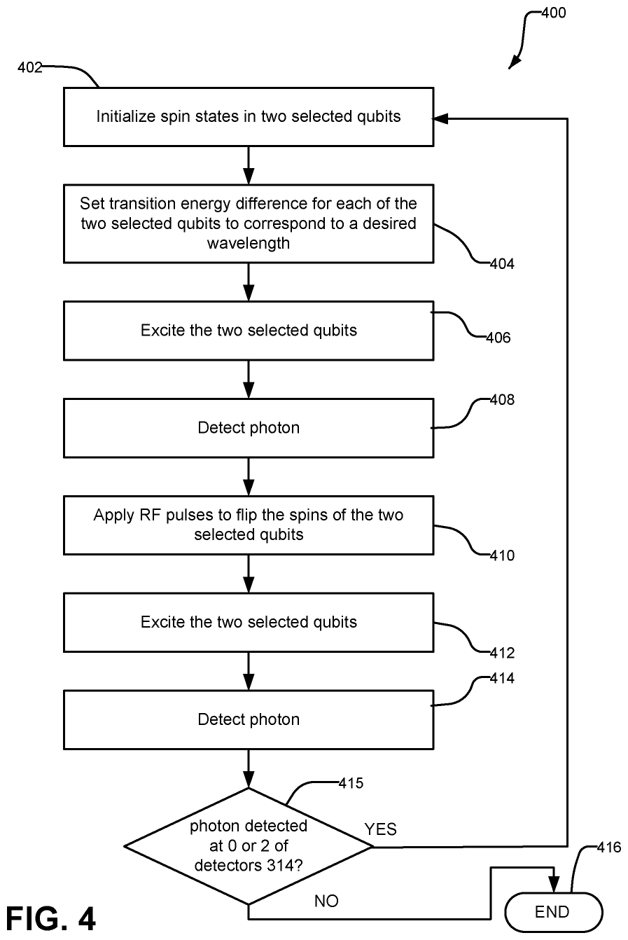

FIG. 4 is a flow chart for a method 400 for heralded entanglement of two quantum systems. At step 402, controller 316 controls frequency controllers 318 to set the transition energy difference in two selected quantum systems to correspond to a desired common frequency. For example, the two selected quantum systems may be quantum systems 302A and 302B and controller 316 may control wavelength controllers 318A and 318B to set the frequencies of optical transition to a common frequency, e.g., corresponding to λ1.

Step 404 initializes spin states in the two selected quantum systems to an initial state which is a superposition of a first state in which the quantum system will emit a photon in response to being excited and a second state in which the quantum system will not emit a photon in response to being excited. Such a state may, for example comprise the state:

$$\frac{\vert ↑ 〉 + \vert ↓ 〉}{\sqrt{2}}$$

At step 406, controller 316 controls lasers 320 to excite the two selected quantum systems (e.g. 302A and 302B) thereby potentially causing each of the quantum systems to emit a photon at a frequency corresponding to wavelength λ1. Quantum system 302A may emit photon state 315A, which is coupled into waveguide 305A by way of optical cavity 304A. When photon state 315A reaches optical resonator 308A-1 (corresponding to wavelength λ1), the photon state is redirected onto branch waveguide 313A-1. Similarly, quantum system 302B may emit photon state 315B, which is coupled into waveguide 304B by way of by optical cavity 304B. Photon state 315B reaches optical resonator 308B-1 (corresponding to wavelength λ1) which redirects photon state 315B onto branch waveguide 313B-1. Photon states 315A and 315B keep travelling on their respective paths until they reach interaction zone 327 at the same time where photon states 315A and 315B can interfere with one another.

Photon detectors 314 detect single photons. Detection of a photon at one of the two detectors 314 of the interference unit at the conclusion of step 408 indicates that the entanglement protocol is so far successful. If both of photon detectors 314 detects a photon in step 408 or if neither one of photon detectors 314 detects a photon in block 408 then the entanglement attempt is marked as a failure. Method 400 subsequently retries the entanglement protocol by returning to step 404 and starting over again.

In method 400, even if the result of step 408 is not the detection of a photon by exactly one of detectors 314, subsequent method steps are executed for the purpose of simplifying control. In the alternative, method 400 could immediately loop back to step 404 unless the result of step 408 is the detection of a photon by exactly one of detectors 314.

If one photon is detected at step 408 then method 400 proceeds to step 410. At step 410, controller 316 controls RF pulsers 322 to flip the spins of the two selected quantum systems 302A and 302B. At step 412, controller 316 controls lasers 320 to excite quantum systems 302A and 302B again thereby causing them to each emit photon states at frequencies corresponding wavelength λ1. These photon states may proceed as described above to interaction zone 327 where they may interfere with one another.

Successful entanglement is heralded by another photon detection by only one of single photon detectors 314. if neither of the corresponding single photon detectors 314 detects a photon (i.e., 0 clicks) or both detectors 314 detect a photon (i.e., 2 clicks), then the entanglement protocol has failed and method 400 loops back to step 404 to try again. On the other hand, if again only one of photon detectors 314A and 314B detects a photon (i.e., 1 click), then the entanglement scheme has succeeded and the quantum states of quantum systems 302A and 302B are entangled.

In FIG. 4, step 415 determines whether zero or two of detectors 314 detected a photon in each of steps 408 and 414 (YES result in step 415). If so, method 400 has failed to establish heralded entanglement and step 415 loops method 400 back to step 404. A NO result in step 415 corresponds to the case where exactly one of detectors 314 detected a photon in each of steps 408 and 414 (heralding entanglement of the corresponding quantum systems). In case of a NO result step 415 causes method 400 to conclude at block 416.

Method 400 may be applied to any pair of the quantum systems of photonic circuit 350 or photonic network 300. Furthermore, method 400 may be applied simultaneously to a plurality of pairs of quantum systems in a photonic network 300 because the different pairs of quantum systems may be operated at different wavelengths (e.g., λ1 to λ5) within the accessible frequency range of the optical cavities. Photons with wavelength λ5 would only respond to the optical resonator operating at wavelength λ5 and ignore all the other optical resonators.

For example, if method 400 were applied to quantum system 302A and 302C at wavelength λ3, then the photon emitted by quantum system 302A would ignore optical resonator 308A-1 and only respond to optical resonator 308A-2. Similarly, the photon emitted by quantum system 304C would ignore optical resonator 308C-1 and only respond to optical resonator 308C-3. Neglecting the possibility of photon loss, the photons would end up at either one of photon detectors 314.

It can be appreciated that the systems and methods described herein may be implemented in ways that facilitate entanglement of different pairs of qubits without any active optical switches. This is particularly beneficial in cases where qubits are operated at cryogenic temperatures (e.g. temperatures of a few Kelvin or less) since optical switches tend to not operate quickly or well or at all at cryogenic temperatures.

### Interpretation

Where a component (e.g. a controller, processor, resonator, waveguide, interference unit, photon detector, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Controllers as described herein may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Some implementations of the invention are in the form of program products. The program products may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, as well as all other numerical values that are near to or approximately equal to that numerical value. A particular numerical value is included in “about” a specifically recited numerical value where the particular numerical value provides the substantial equivalent of the specifically recited numerical value in the context in which the specifically recited numerical value is presented.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are described in relation to different drawings and/or in different paragraphs or sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for routing single photons to selected destinations, the method comprising:
providing a single photon source optically coupled to a frequency demultiplexer of a photonic network, the frequency demultiplexer comprising a plurality of outputs, each of the plurality of outputs associated with a respective frequency band;
directing a photon from the single photon source to a selected one of the outputs by configuring the single photon source to emit photons having frequencies lying within the one of the frequency bands corresponding to the selected output and controlling the single photon source to emit the photon.

2. The method according to claim 1 wherein the frequency demultiplexer comprises an optical waveguide coupled to the single photon source and a plurality of frequency selective dropout filters optically coupled to the waveguide, each of the dropout filters configured to couple photons from the optical waveguide to a corresponding one of the outputs if the photons have frequencies within the one of the frequency bands associated with the one of the outputs and the method comprises coupling the photon from the optical waveguide to the selected output by the dropout filter corresponding to the selected output.

3.-8. (canceled)

9. The method according to claim 1 wherein the single photon source comprises a quantum system having plural quantum states and controlling the single photon source to emit the photon comprises configuring the quantum system in a first quantum state corresponding to a first energy level and allowing the quantum system to undergo a transition from the first quantum state to a second quantum state having a second energy level lower than the first energy level, the photon being emitted as a result of the transition.

10.-11. (canceled)

12. The method according to claim 9 wherein the quantum system comprises a luminescent center in a substrate, and wherein the luminescent center comprises a T-center, I-center or an M-center.

13. (canceled)

14. The method according to claim 1 wherein the single photon source is a first single photon source, the photon is a first photon and the method further comprises routing the first photon from the first single photon source to an interaction location and routing a second photon from a second single photon source to the interaction location and allowing the first and second photons to interact at the interaction location.

15. The method according to claim 14 comprising entangling quantum states of the first and second single photon sources, wherein routing the second photon from the second single photon source to the interaction location comprises directing the second photon to the interaction location and configuring the second single photon source to emit second photons having frequencies lying within a wavelength band that corresponds to a selected output of a second frequency demultiplexer of the photonic network, controlling the second single photon source to emit the second photon and coupling the second photon into the second frequency demultiplexer of the photonic network.

16. (canceled)

17. The method according to claim 1 wherein configuring the single photon source to emit photons having frequencies lying within the one of the wavelength bands comprises setting one or more of a magnetic field and an electric field at a location of the single photon source.

18.-40. (canceled)

41. A system for routing single photons to selected destinations, the system comprising:
a first single photon source optically coupled to a first frequency demultiplexer of a photonic network, the frequency demultiplexer comprising a plurality of outputs, each of the plurality of outputs associated with a respective one of a plurality of frequency bands;
a control system operative to selectively set frequencies of photons emitted by the first single photon source to a frequency within one of the plurality of frequency bands and to cause the single photon source to emit photons into the photonic network.

42. The system according to claim 41 wherein the single photon source comprises a quantum system having a plurality of quantum states, each of the quantum states having a corresponding energy level and the controller comprises a light source operative to excite the quantum system to a quantum state associated with an excited one of the energy levels via a first quantum transition by directing light onto the quantum system.

43.-44. (canceled)

45. The system according to claim 41 wherein the frequency demultiplexer comprises an optical waveguide coupled to the single photon source and a plurality of frequency selective dropout filters optically coupled to the waveguide, each of the dropout filters configured to couple photons from the optical waveguide to a corresponding one of the outputs if the photons have frequencies within the one of the frequency bands associated with the one of the outputs.

46. The system according to claim 45 wherein each of the dropout filters comprises a resonator having a bandwidth that includes the corresponding frequency band.

47. The system according to claim 46 comprising a resonant optical structure operative to couple single photons from the single photon source into the photonic network.

48. The system according to claim 47 wherein the resonant optical structure has an optical bandwidth that includes all of the frequency bands, wherein the resonant optical structure is characterized by a first quality factor (Q1) and the resonators of the dropout filters each has a corresponding second quality factor (Q2) and the second quality factors are greater than the first quality factor.

49.-51. (canceled)

52. The system according to claim 41 comprising a refrigerator operative to cool the single photon source and the photonic network to cryogenic temperatures.

53. (canceled)

54. The system according to claim 41 wherein the single photon source comprises a luminescent center in a substrate and wherein the luminescent center comprises a T-center, I-center or an M-center.

55.-56. (canceled)

57. The system according to claim 41 comprising a second single photon source coupled to emit photons into a second frequency demultiplexer of the photonic network, the second frequency demultiplexer comprising a plurality of outputs, each of the plurality of outputs associated with a respective one of the plurality of frequency bands;
wherein the control system is operative to selectively set frequencies of photons emitted by the second single photon source to a frequency within one of the plurality of frequency bands and to cause the second single photon source to emit photons into the photonic network.

58. The system according to claim 57 wherein the photonic network comprises an interaction location and one output of each of the first and second frequency demultiplexers is optically connected to deliver photons to the interaction location, wherein the one output of each of the first and second frequency demultiplexers correspond to the same one of the set of frequency bands.

59. (canceled)

60. The system according to claim 58 wherein the interaction zone comprises an interference unit.

61. (canceled)

62. The system according to claim 41 wherein system comprises three or more single photon sources including the first single photon source, each of the three or more single photon sources optically connected to a corresponding frequency demultiplexer of the photonic network, and the control system is configured to direct photons emitted by any of a plurality of pairs of the single photon sources to one of a plurality of interaction zones provided in the photonic network by setting the single photon sources of one of the pairs of single photon sources to emit photons having frequencies that correspond to the one of the plurality of interaction zones.

63. (canceled)

64. The system according to claim 62 wherein the controller is configured to execute a heralded entanglement protocol to entangle quantum states of the pair of single photon sources.

65.-70. (canceled)
